(19) United States
(12) Patent Application Publication
(10) Pub. No.: US 2026/0098593 A1
(43) Pub. Date: Apr. 9, 2026

(54) DIAGNOSING PART BEHAVIOR ON A CONTROL VALVE

(71) Applicant: Dresser, LLC, Houston, TX (US)

(72) Inventors: Octavio Narvaez Aroche, Mexico City (MX); Brian Paul Reeves, Edmond, OK (US)

(21) Appl. No.: 18/905,883

(22) Filed: Oct. 3, 2024

(51) Int. Cl. F16K 37/00

(52) U.S. Cl. CPC F16K 37/0091

(57) ABSTRACT

A monitoring device that is configured to diagnose potential issues on a valve. The monitoring device may include a sensor network that measures variables on or around the valve. The sensor network provides data to processing hardware with executable instructions that define methods to process the data. In one implementation, these methods may generate a trajectory for performance of the flow control and compare this “real” trajectory to a model trajectory. The methods may, in turn, determine a relationship between the real trajectory and the model trajectory to identify potential or possible failure conditions on the device. The method may also generate an output that corresponds with this relationship.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Valves are a type of flow control that operators favor to regulate flow of material (or “process fluid”) on their process lines. These devices may comprise a valve body that houses valve “trim,” typically a cage, a closure member, and a seat. A superstructure like a bonnet (or cover) may secure to the valve body. The bonnet may have a through-bore to receive a valve stem that connects the closure member to an actuator. Packing material may reside in the through-bore and surround the valve stem to prevent any leak of process fluid that might escape the valve body into the through-bore.

### SUMMARY

The subject matter of this disclosure relates to improvements to diagnostics on flow controls. Of particular interest are embodiments that can predict behavior of parts or components of flow controls without the need to directly measure performance with a sensor or other monitoring hardware. These embodiments, instead, utilize an “observer” that may rely on data from sensors already in place on the device to estimate values for operating conditions or variables, like displacement, flow volume or flow rate, actuation speeds, and the like. This feature is beneficial because it can allow operators to schedule maintenance at appropriate times, for example, before component problems seriously degrade performance or result in outright failure of the device.

### DRAWINGS

This specification refers to the following drawings:

FIG. 1 depicts a schematic diagram of an exemplary embodiment of monitoring hardware for use on a flow control;

FIG. 2 depicts a schematic diagram of operating hardware for use in the monitoring hardware of FIG. 1;

FIG. 3 depicts a flow diagram for an exemplary method for the monitoring hardware of FIG. 2 to predict behavior on a flow control;

FIG. 4 depicts a plot of data that describes an example of behavior of a part on a flow control;

FIG. 5 depicts a plot of data that describes an example of model behavior for the part of FIG. 4;

FIG. 6 depicts a plot of data that overlays predicted behavior and model behavior for the part of FIGS. 4 and 5;

FIG. 7 depicts a perspective view of an example of a flow control; and

FIG. 8 depicts a perspective view of an example of a controller for use on a flow control.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

The discussion now turns to describe features of the examples shown in the drawings noted above. At a high level, design of flow controls, like control valves, often uses nominal values for design variables to arrive at a design that meets an operator's performance goals for the device. Original equipment manufacturers (OEMs) and operators recognize, though, that machine tolerances, component wear, or other manufacturing, assembly, or use factors can impact operation of the device from the time the device begins its service life on a process line. These variations require operators to accept that device performance likely with fall with certain “tolerances” about some nominal value. The discussion below proposes to use numerical simulations to create a baseline performance for flow controls. This baseline performance can help to predict or diagnose problems that are, or are likely, to occur as the device continues to function on the process line. Other examples and embodiments are within the scope of this disclosure.

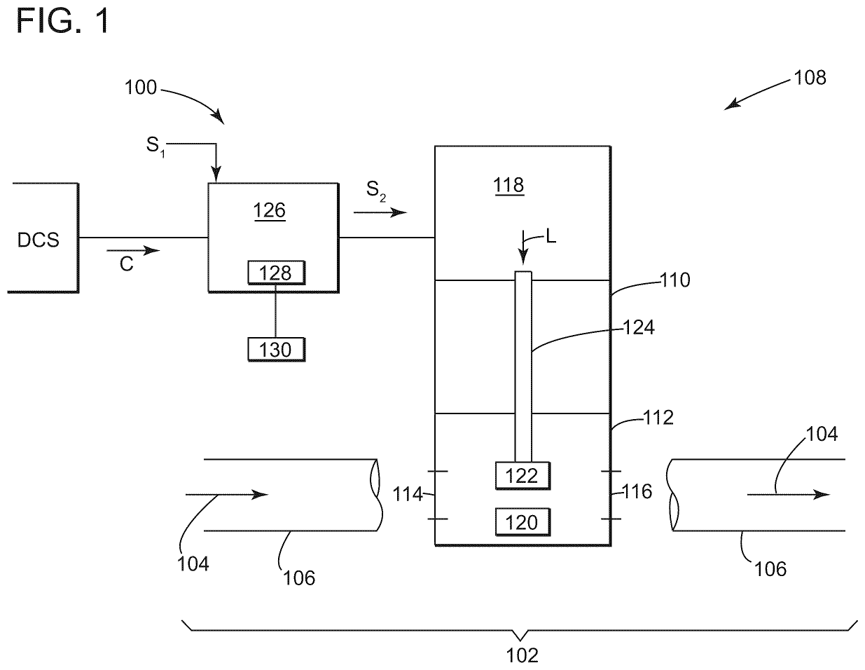

FIG. 1 depicts a schematic diagram of an exemplary embodiment of monitoring device 100. This embodiment is found in a distribution network 102, typically designed to carry material 104 through conduit 106. As shown, the monitoring device 100 is part of a flow control 108 that may integrate into the network 102. The flow control 108 may include a superstructure 110. As shown, a valve body 112 with openings (e.g., an inlet 114 and an outlet 116) may reside on one side of the superstructure 110. An actuator 118 may reside on the other side of the superstructure 110. Inside of the valve body 112, the device may include a seat 120 and a closure member 122. A valve stem 124 may couple the closure member 122 with the actuator 118. In one implementation, the monitoring device 100 may include a controller 126 (or “valve positioner”) and operating hardware, shown here to include processing hardware 128 that couples with a sensor network 130.

Broadly, the monitoring device 100 may be configured to diagnose health of a device on a process line. These configurations may utilize algorithms to project or interpolate values for both measured and unmeasured “variables of interest” (“VOI”) to estimate performance of the device out into the future. Values for VOI may generally describe behavior of specific parts or operations the device, for example, “diaphragm stack displacement,” “diaphragm stack speed,” “volume of gas traversing the flow control,” or “volumetric flow rate,” among others. The algorithms may compare these values to models or simulations to diagnose potential problems and, for example, provide operators with forward-looking alerts to perform service or maintenance prior to any catastrophic failure.

The distribution network 102 may be configured to deliver or move fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The flow control 108 may be configured to regulate flow of material 104 through the conduit 106 in these complex networks. These configurations may include valves, control valves and like devices. The superstructure 110 may be configured with a robust, industrial design that can support components of the flow control 108. These configurations may include a “bonnet” as found on some types of valves. The valve body 112 in these devices is often made of cast or machined metals. This part may have flanges or another connective feature at the openings 114, 116. Adjacent pipes 106 may connect or bolt to these flanges to allow material 104 to flow into and out of the device. The actuator 118 may embody pneumatic or electrical devices. The valve seat 120 and the closure member 122 may adopt construction that allows the flow control 108 to operate under extreme conditions, including with materials 104 that are caustic or hazardous. The valve stem 124 may embody an elongated member, for example, a metal rod or shaft that can direct load L from the actuator 118 to the closure member 122. This shaft may have a cross-section that is round or circular; but other shapes may find use in certain applications as well.

The controller 126 may be configured to process and generate signals. These configurations may connect to a control network (or “distributed control system” or “DCS”). Generally, the DCS may maintain operation of all devices on process lines to ensure that material 104 flows in accordance with a process or meets certain process parameters. It may also generate control signals C with operating parameters that describe or define operation of the flow control 108 for this purpose. The controller 126 may employ electrical and computing components, like processors and memory storage (with data and executable instructions), to process the control signals C. The components may also include electro-pneumatic devices that operate on incoming pneumatic supply signal S₁, typically instrument air at process facilities. These components may generate an outgoing actuator control signal S₂ that is appropriate for the flow control 108 to supply material 104 downstream according to process parameters. In one implementation, the actuator control signal S₂ may pressurize the inside of the actuator 118. The pressure works with other components in the actuator 118 (like springs and diaphragms) to generate a load L on the valve stem 124. The load L may set the operating condition on the flow control 108, which in turn regulates flow of material 104 through the device to satisfy requirements on the process line.

The operating hardware 128, 130 may be configured to predict behavior of parts on the flow control 108. These configurations may embody electrical computing devices, like processors, memories, sensors, and the like in combination with certain algorithms or processes. These devices can collect data that relates or describes operation of the flow control 108. The algorithms, in turn, can use this data to create predictive models of performance on a part-by-part or system-level basis.

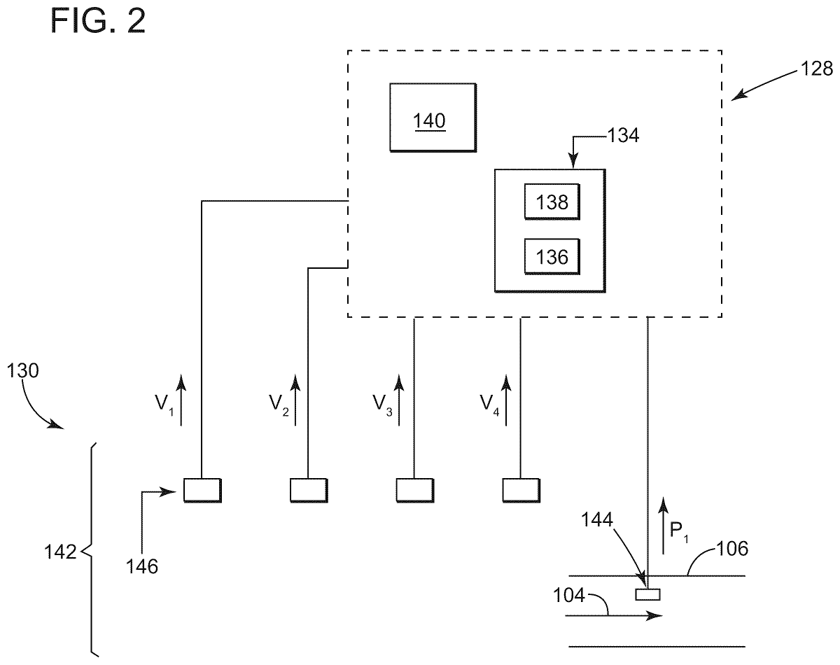

FIG. 2 depicts a schematic diagram of an example of the operating hardware 128, 130 for this purpose. The processing hardware 128 may include memory storage 134 that may contain data 136 and executable instructions 138. A processor 140 may access and execute the executable instructions 138, which configure the processor 140 to perform certain functions. The sensor network 130 may include sensors 142 that are found throughout the flow control 108. The sensors 142 may include process sensors 144, like flow, temperature, or pressure gauges, that can provide data about flow conditions of material 104 as it flows through conduit 106. As also shown, the sensors 142 may include machine or device sensors 146 that may reside on or in proximity to the flow control 108 (FIG. 1). These sensors may include accelerometers, strain gauges, pressure gauges, temperature gauges, and the like, to provide data about conditions of the flow control 108 (FIG. 1).

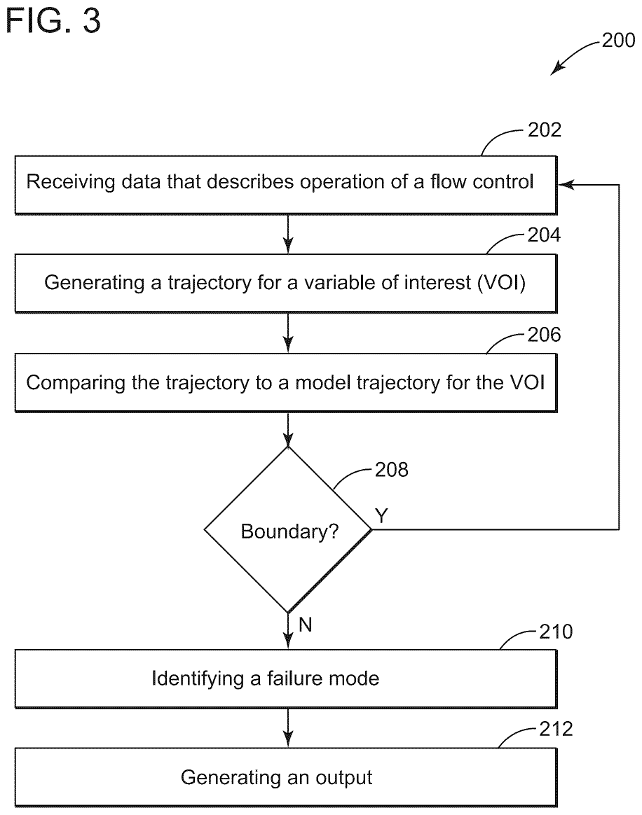

FIG. 3 depicts a flow diagram for an example of a method 200 to process data to predict behavior of parts on the flow control 108 (FIG. 1). This diagram outlines stages that may embody executable instructions for one or more computer-implemented methods or processes. The stages in these methods may be altered, combined, omitted, or rearranged in some embodiments. The executable instructions may instantiate a computer program, software, firmware, or like compilation of machine-readable instructions. In one implementation, the method 200 may include, at stage 202, receiving data that describes operation of a flow control and, at stage 204, generating a trajectory for a variable of interest (“VOI”). The method 200 may also include, at stage 206, comparing the trajectory to a model trajectory for the VOI. At stage 208, if the trajectory resides between boundaries of the model trajectory, the method 200 may continue at stage 202. If not, then the method 200 may include stages for identifying a failure mode (at stage 210) and generating an output (at stage 212) to convey the failure mode.

At stage 202, the method 200 may receive data. In one implementation, sensors 142 may generate signals consistent with variables that define performance of the flow control 108 (FIG. 1). These “measured” variables may include process variable P₁ from the process sensor 144 (FIG. 2). This variable may measure flow rate, temperature, or pressure of material 104 (FIG. 2). The device sensors 146 may provide data about device variables, including supply or inlet pressure V₁, diaphragm pressure V₂, actuator pressure V₃, valve position V₄ (or position of the closure member 124), and the like. The processing hardware 128 may store this data on storage memory 134.

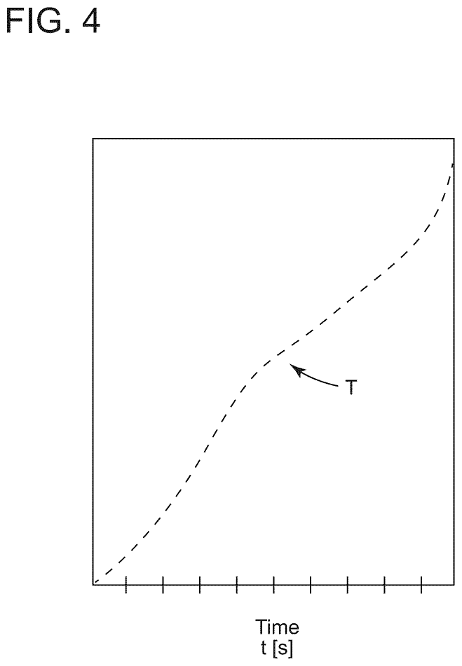

At stage 204, the method 200 may generate the trajectory. Executable instructions 138 may include instructions for an “observer,” for example, one or more equations, including physics-based equations. The “observer” may use the measured variables to generate values for one or more VOI. This feature is useful because flow control 108 (FIG. 1) is generally not setup to measure the values for VOI directly. FIG. 4 depicts a plot of data for an example of a trajectory T. As shown, data from the observer estimates or interpolates values for the VOI over time to predict performance of parts on the flow control 108.

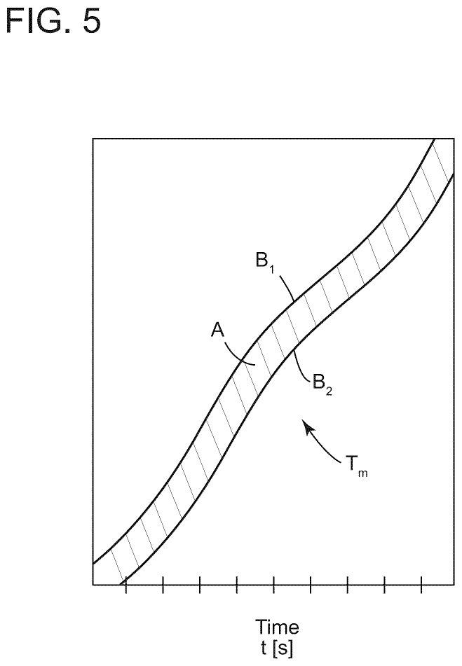

At stage 206, the method 200 may compare the real trajectory to the model trajectory. In one implementation, the model trajectory corresponds with data that results from “stochastic” simulations. This data models a response (including a time response) of parts of the flow control 108 to parameter uncertainty. OEMs may run these simulations and store or upload the data onto storage memory 134 at assembly or periodically when the device is in the field. FIG. 5 depicts a plot of data for an example of a model trajectory T_{M} that results from stochastic simulations. The model trajectory T_{M} may represent model behavior for a specific part on the flow control, like a relay, under “nominal” operating conditions. In this example, the model trajectory T_{M} includes an area A that corresponds with an aggregate of many (e.g., 100) simulations that use random samples for any uncertain variables. The simulations define an upper boundary B₁ and a lower boundary B₂ for the area A that represent outer limits of acceptable operation for the part that is subject to the analysis.

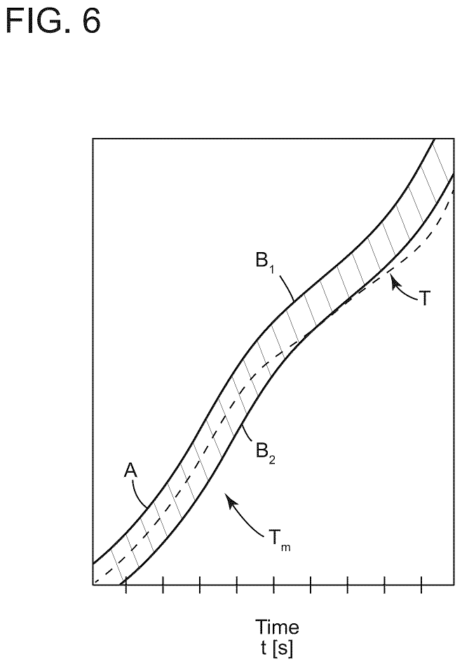

At stage 208, the method 200 determines the relationship between the trajectory T and the model trajectory T_{M}. This relationship is useful to diagnose performance issues, or the potential for performance issues, that might occur on the flow control 108. FIG. 6 depicts a plot of the trajectory T and the model trajectory T_{M}. As shown, the trajectory T crosses the lower boundary B₂ of the model trajectory T_{M}, which indicates the potential for performance issues to occur in the future on the device.

At stage 210, the method 200 may identify the failure mode that corresponds with the predicted performance of the VOI. In one implementation, data 136 may also include data that defines or describes “classes” or classifications of failure modes that may occur on the flow control 108. These failure modes may include diaphragm tear, broken spring(s), leaks, excessive friction, part erosion, cavitation, loss of stability and control, among others. Examples of the failure mode may require an end user to perform various tasks, including periodic or regular maintenance or repair. The end user may need to replace the flow control 108, altogether.

At stage 212, the method 200 may generate the output in accordance with the failure mode. The output may embody any number of audio or visual cues to alert an end user about the condition of the flow control 108. The subject matter of these cues may correspond with the severity of the failure mode, for example, a LED may illuminate or an alarm may sound on the flow control 108 in response to maintenance or repair, respectively. For serious malfunctions, the device may go inactive or enter a reduced function mode that prevents certain (or all) functionality of the flow control 108. Any of these specific responses may combine with others as well. In one implementation, the flow control 108 may also generate a signal that encodes data, for example, an email or text message, that will resolve on a computing device or system, like an end user's laptop, smartphone, or tablet.

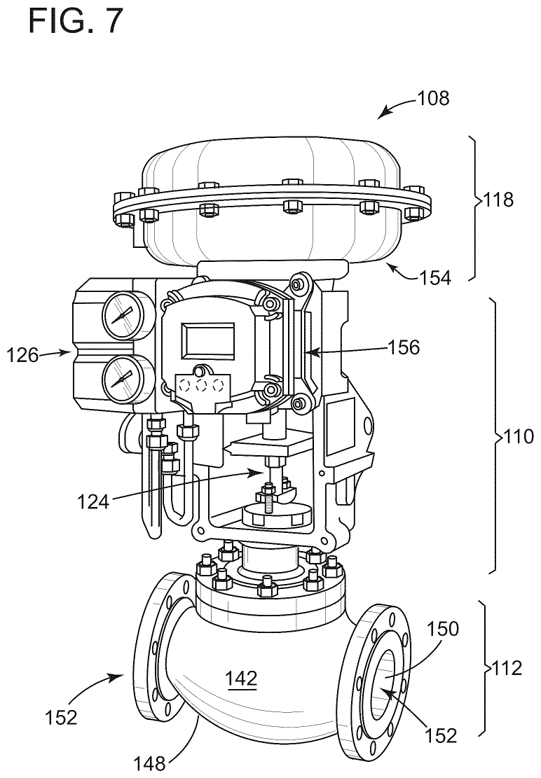

FIG. 7 depicts a perspective view of exemplary structure for the flow control 108. This example reflects structure of a typical globe control valve; however, the disclosure contemplates use of the proposed design in any industrial valve device, including rotary valves like ball valves, butterfly valves, or globe valves. As shown, the valve body 112 may include a fluid coupling 148 that forms a flow path 150 with flanged, open ends 152. The fluid coupling may enclose the valve mechanics, like the seat 120 (FIG. 1) and the closure member 122 (FIG. 1) (both hidden in the present view). This structure may be useful to regulate process fluids in industrial process lines typical of industries that focus on chemical production, refining production, and resource extraction. The superstructure 110 may secure to the fluid coupling 148. The superstructure 110 may support the actuator 118, shown here to have a bulbous housing 154 that is typically two pieces that clamp about the edges to entrap a diaphragm (not shown) round the periphery. The controller 126 may mount onto a bracket 156 that itself either secures to or incorporates as part of the superstructure 110. The controller 126 can deliver instrument air at appropriate pressure to the pneumatic actuator 118, which utilizes the pressurized fluid to generate the load L (FIG. 1).

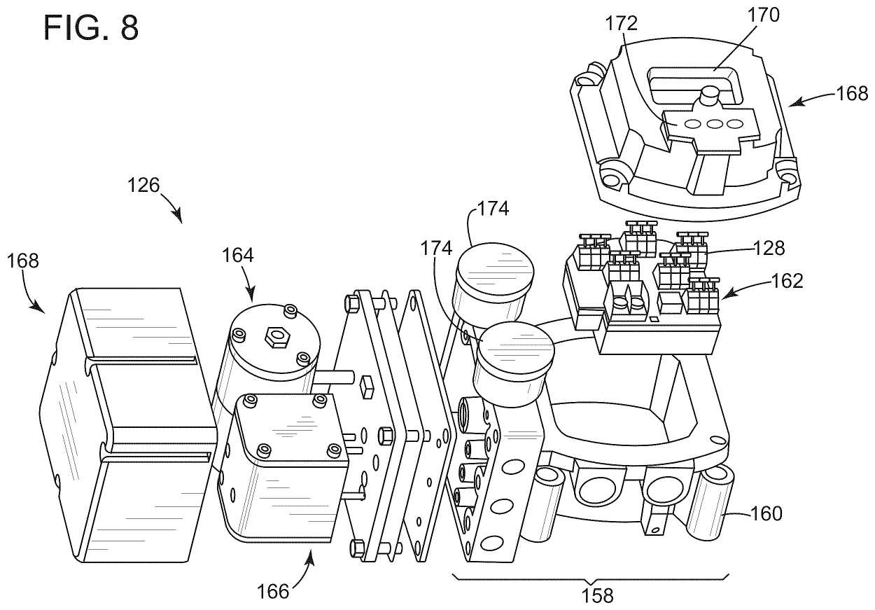

FIG. 8 depicts a perspective view of exemplary structure for the controller 126 in exploded form. This structure may include a manifold 158 having a manifold body 160, typically machined or formed metal, plastic, or composite. The device may include one or more boards 162, which can have components for the processing hardware 128 disposed thereon. Other hardware may include a current-to-pressure converter 164 and a pneumatic relay 166. The components 164, 166 work together to deliver an actuator signal (for example, instrument air or current) to the actuator 118. As also shown, the controller 126 may have an enclosure, shown as covers 168 in this example. The covers 168 may secure to the manifold body 160 to protect the control components from conditions that prevail in the environment surrounding the flow control 108 (FIG. 7). One of the covers 168 may incorporate a display 170 and a pushbutton input device 172 that may operate as the primary local user interface to allow an end user (e.g., technician) to interact with the controller 126. This feature may be important for regular maintenance, configuration, and setup, for example, to allow the end user to exit from valve operating mode and step through a menu structure to manually perform functions such as calibration, configuration, and monitoring. In one implementation, the controller 126 may further include one or more gauges 174 that can provide an indication of the flow conditions (e.g., pressure, flow rate, etc.) of the fluid that the controller 126 uses to operate the valve assembly 108 (FIG. 1).

Considering the foregoing, the improvements herein can help operators predict future performance gaps or issues on their process lines. The embodiments may use the observer to predict values for variables of interests, or VOI, that a valve or other flow control is not setup to measure directly in the field. This observer may use physical models and other data the system collects from existing sensors to generate these values for the VOI. The embodiments may, in turn, compare these values to performance data that results from models or simulations, often done offline and stored on the device for this purpose.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A method, comprising:
receiving data from sensors, the data defining conditions on a flow control;
generating a trajectory from the data that predicts performance of a part on the flow control;
comparing the trajectory to a model trajectory;
identifying a failure mode in response to a relationship between the trajectory and the model trajectory; and
generating an output in response to the relationship, the output relating to the failure mode.

2. The method of claim 1, further comprising:
using an observer and data points for generate the trajectory.

3. The method of claim 1, wherein the trajectory includes data points interpolated from data from the sensors.

4. The method of claim 1, wherein the model trajectory defines performance of the part under nominal operating conditions.

5. The method of claim 1, wherein the model trajectory comprises an upper boundary and a lower boundary.

6. The method of claim 1, wherein the model trajectory defines an area that represents outer performance limits for the part.

7. The method of claim 1, wherein the model trajectory describes an area that corresponds with data aggregated from a plurality of simulations of performance of the part.

8. The method of claim 1, wherein the model trajectory describes an area that corresponds with data aggregated from a plurality of simulations done with samples of uncertain parameters.

9. The method of claim 1, wherein the model trajectory corresponds to simulations done remote from the flow control.

10. The method of claim 1, wherein the output deactivates the flow control.

11. The method of claim 1, wherein the output causes the flow control to operate in a reduced function mode.

12. A flow control, comprising:
a valve body housing a closure member and a seat;
a valve stem coupled to the closure member;
an actuator coupled to the valve stem;
a controller coupled to the actuator; and
sensors coupled to the controller,
wherein the controller is configured to,
receive data from sensors, the data defining conditions on the flow control;
generate a trajectory from the data that predicts performance of a part on the flow control;
compare the trajectory to a model trajectory;
identify a failure mode in response to a relationship between the trajectory and the model trajectory; and
generate an output in response to the relationship, the output relating to the failure mode.

13. The flow control of claim 12, wherein the model trajectory defines performance of the part under nominal operating conditions.

14. The flow control of claim 12, wherein the model trajectory comprises an upper boundary and a lower boundary.

15. The flow control of claim 12, wherein the model trajectory defines an area that represents outer performance limits for the part.

16. The flow control of claim 12, wherein the model trajectory describes an area that corresponds with data aggregated from a plurality of simulations of performance of the part.

17. The flow control of claim 12, wherein the model trajectory describes an area that corresponds with data aggregated from a plurality of simulations done with samples of data from the sensors.

18. The flow control of claim 12, wherein the model trajectory corresponds to simulations done remote from the flow control.

19. The flow control of claim 12, wherein the trajectory includes data points interpolated from data from the sensors.

20. The flow control of claim 12, wherein the output deactivates the flow control.
